(19) United States
(12) Patent Application Publication
(10) Pub. No.: US 2016/0099588 A1
(43) Pub. Date: Apr. 7, 2016

(54) CHARGING ELECTRONIC DEVICE AND METHOD FOR CONTROLLING POWER IN CHARGING ELECTRONIC DEVICE

(71) Applicant: Samsung Electronics Co., Ltd., Gyeonggi-do (KR)

(72) Inventors: Chan-Jung BAE, Gyeonggi-do (KR); Hyun-Sup PARK, Seoul (KR); Kyung-Woo LIM, Gyeonggi-do (KR); Seung-Ju LEE, Gyeongsangbuk-do (KR)

(21) Appl. No.: 14/876,957

(22) Filed: Oct. 7, 2015

(30) Foreign Application Priority Data
Oct. 7, 2014 (KR) 10-2014-0135264

(51) Int. Cl. H02J 7/00

(52) U.S. Cl. CPC H02J 7/0024; H02J 7/007; H02J 7/0019; H02J 2007/0095; H02J 2007/0096

(57) ABSTRACT

According to various embodiments, a charging electronic device may include: a communication module configured to receive one or more types of power; a power control module configured to charge or discharge a battery module with selected power among the one or more types of power; and a control module configured to change a charging condition or discharging condition of the power control module to correspond to the selected power among the one or more types of power to charge or discharge the battery module. Other embodiments are also possible.

### CLAIM OF PRIORITY

This application claims priority under 35 U.S.C. §119(a) to Korean Application Serial No. 10-2014-0135264, which is filed in the Korean Intellectual Property Office on Oct. 7, 2014, the entire content of which is hereby incorporated by reference.

### TECHNICAL FIELD

Various embodiments relate to a device and a method for controlling power in the device.

### BACKGROUND

A portable auxiliary battery pack refers to a product that charges an electronic device, and typically can be connected to a rechargeable battery or an electronic device through a terminal portion such as an interface (for example, Micro USB, USB A). The portable auxiliary battery pack can charge an internal battery with power supplied from a charger connected through an input terminal module. Further, the portable auxiliary battery pack supplies power to the electronic device connected through an output terminal module, thereby the electronic device can receive an additional power through the portable auxiliary battery pack.

### SUMMARY

The portable auxiliary battery pack, typically, is charged with power having one type of DC voltage (for example, 5V) from a charger connected thereto, and is discharged by outputting the power having one type of DC voltage (for example, 5V) to the electronic device connected thereto.

The greater the battery capacity of the portable auxiliary battery pack, the longer the charging time becomes when the portable auxiliary battery pack is charged with power having one type of DC voltage provided from the charger. For example, in case of a portable auxiliary battery pack with a capacity of 10 Ah, unless a very high current is used when charging with power having a voltage of 5V, the charging time becomes longer than 5 hours.

Further, when the power of the portable auxiliary battery pack is output, and even when the power is output to the electronic device connected to power having a voltage of 5V and discharged, the charging time of the electronic device can be longer.

In order to solve the problems mentioned above and other problems, various embodiments may provide a device and a method for controlling power in a device, which are capable of charging or discharging with selected power among one or more types of power.

In order to solve the problems mentioned above and other problems, a device according to an embodiment of the present disclosure is provided. The device includes: a communication module configured to receive one or more types of power; a power control module configured to charge or discharge a battery module with selected power among the one or more types of power; and a control module configured to change a charging condition and discharging condition of the power control module to correspond to the selected power among the one or more types of power to charge or discharge the battery module.

In accordance with an embodiment of the present disclosure, a method for controlling power in a device is provided. The method includes: receiving one or more types of power; changing a charging condition or discharging condition of the power control module in order to charge or discharge a battery module with selected power among the one or more types of power; and charging or discharging the battery module to correspond to the selected power among the one or more types of power.

A device and a method for controlling power in a device according to various embodiments can reduce charging time of the device or charging time of an electronic device by the device.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 shows a block diagram of a device in which a circuit connection of a battery is fixed according to various embodiments of the present disclosure;

FIG. 2 shows a block diagram of a device in which a circuit connection of a battery is not fixed according to various embodiments of the present disclosure;

FIG. 3 is a diagram illustrating a signal for controlling a connection scheme of a battery module depending on a type of charging power in a device in which a circuit connection of a battery is not fixed according to various embodiments of the present disclosure;

FIG. 4 shows a flow chart illustrating a power charging method in a device according to various embodiments of the present disclosure;

FIG. 5 shows a flow chart illustrating a power discharging method in a device according to various embodiments of the present disclosure; and

FIG. 6 shows a flow chart illustrating a simultaneous charging method by a circuit connection of a battery in a device according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

In the present disclosure, the expression “have”, “may have”, “include” or “may include” refers to existence of a corresponding feature (e.g., numerical value, function, operation, or components such as elements), and does not exclude existence of additional features.

In the present disclosure, the expression “A or B”, “one or more of A or/and B”, or “one or more of A or/and B” may include all possible combinations of the items listed. For example, the expression “A or B”, “one or more of A and B”, or “one or more of A or B” refers to all of (1) including one or more A, (2) including one or more B, or (3) including all of one or more A and one or more B.

The expression “a first”, “a second”, “the first”, or “the second” used in various embodiments of the present disclosure may modify various components regardless of the order and/or the importance but does not limit the corresponding components. The above expressions are used merely for the purpose of distinguishing an element from the other elements. For example, the first user equipment and the second user equipment, regardless of the order or importance, and may represent a different user equipment. For example, a first element may be termed a second element, and similarly, a second element may be termed a first element without departing from the scope of the present disclosure.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure. In some cases, even the term defined in the present disclosure should not be interpreted to exclude embodiments of the present disclosure.

For example, the electronic device may include one or more of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic accessory, electronic tattoos, or a smart watch).

According to some embodiments, the electronic device may be a smart home appliance. The home appliance may include one or more of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include one or more of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include one or more of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

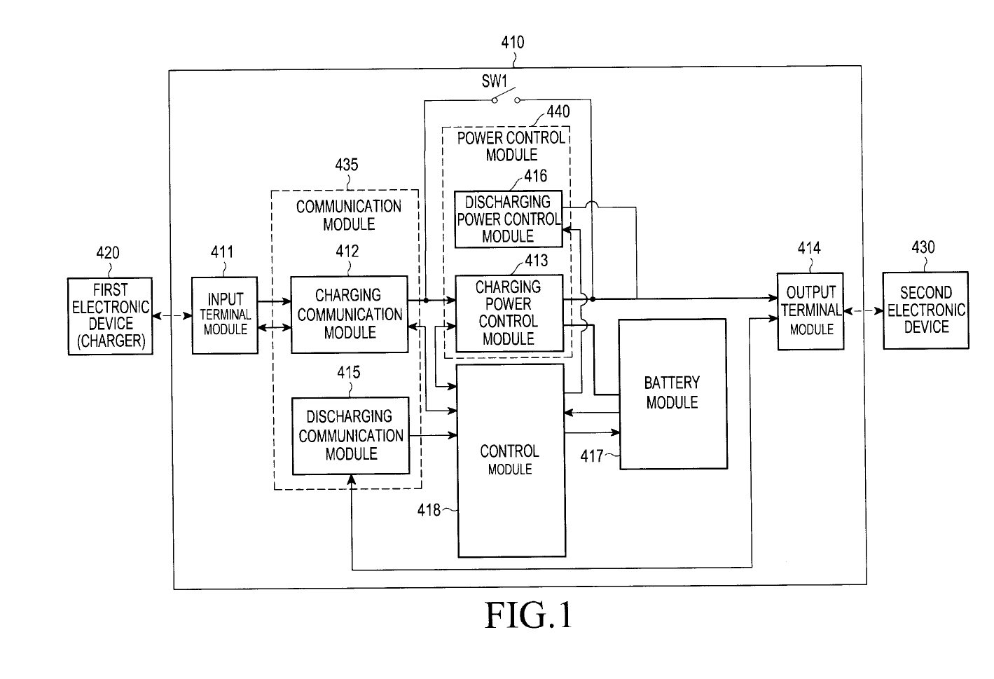

FIG. 1 shows a block diagram of a device 410 with a fixed circuit connection of a battery according to various embodiments of the present disclosure. For example, the above device (410) can be detachable battery pack to the second electronic device (430).

Referring to FIG. 1, the device 410 may include an input terminal module 411, an output terminal module 414, a communication module 435, a power control module 440, a battery module 417, and a control module 418. The communication module 435 may include a charging communication module 412 and a discharging communication module 415 that receives one or more types of power. The power control module 440 may include a charging power control module 413 and discharging power control module 416 configured to charge or discharge the battery module with selected power among the one or more types of power.

The device 410 is configured to charge itself or discharge to a second electronic device 430, according to a type of power provided by the first electronic device 420. The charging communication module 412 receives information on the type of power being provided by the first electronic device 420 and transmits the information to the control module 418. The control module 418 configures the charging power control 413 to set a charging current condition corresponding to the type of power provided by the first electronic device 420. The charging block module 413 may charge the battery module 417 corresponding to the type of power provided by the first electronic device 420. The discharging communication module 415 receives information on the type of power being provided by the second electronic device 430 and transmits the information to the control module 418. The control module 418 configures the discharging power control 416 to set a discharging current condition corresponding to the type of power provided by the second electronic device 430. The discharging power control module 416 may discharge the battery module 417 corresponding to the type of power provided by the second electronic device 430.

The input terminal module 411 can be connected to a first electronic device 420 (for example, a charger) capable of supplying one or more types of power to the device 410, and can include an input interface (for example, micro USB connector) to which the first electronic device 420 can be connected.

The charging communication module 412 of the communication module 435 can be operably connected to the input terminal module 411 to communicate with the first electronic device 420.

According to various embodiments, the charging communication module 412 can receive, from the first electronic device 420 (for example, a charger) connected to the input terminal module 411, information on one or more types of power (for example, AC or DC power, supply voltage, maximum transmittable current, etc.) capable of being provided from the first electronic device 420. The foregoing can be via the input terminal module 411.

According to an embodiment, when the first electronic device 420 (for example, a charger) is connected to the input terminal module 411, the charging communication module 412 may perform communication with the first electronic device 420 according to a predetermined communication protocol and receive information on one or more types of power that can be provided from the first electronic device 420. The foregoing can be via the input terminal module 411.

According to an embodiment, when the first electronic device 420 (for example, a charger) is connected to the input terminal module 411, the charging communication module 412 may perform communication with the first electronic device 420 according to a predetermined communication protocol and transmit information on one or more types of power that can be used in the device 410 to the first electronic device 420. The foregoing can be via the input terminal module 411.

According to an embodiment, when the first electronic device 420 is connected to the input terminal module 411, the device 410 is to be the master electronic device, and the first electronic device 420 is to be a slave electronic device, the charging communication module 412 may transmit the information on power from which the device 410 wants to receive to the first electronic device 420. The foregoing can be via the input terminal module 411.

The charging communication module 412, forming part of the communication module 435, is operably connected to the control module 418 to communicate therebetween. According to an embodiment, the charging communication module 412 may transmit information on selected power among one or more types of power to the control module 418.

According to an embodiment, when power having a pre-configured first voltage (for example, 5V) and power having a voltage (for example, 9V) higher than the pre-configured first voltage are provided from the first electronic device 420, and power having a second voltage (for example, 9V) is selected as charging power, the charging communication module 412 may transmit that the power having the second voltage (for example, 9V) is to be provided as charging power to the first electronic device 420.

According to an embodiment, the charging communication module 412 may transmit information indicating that the power having the second voltage (for example, 9V) is to be provided as charging power to the control module 418 if power having a second voltage (for example, 9V) is selected as charging power, when power having a pre-configured first voltage (for example, 5V) and power having a voltage (for example, 9V) higher than the pre-configured first voltage are provided from the first electronic device 420.

The control module 418 can be operably connected to the charging power control module 413 of the power control module 440 to set a charging current of the charging power control module 413.

According to various embodiments, the charging power control module 413 may charge the battery module 417 with a charging condition corresponding to selected power among one or more types of power.

According to an embodiment, the charging power control module 413 may change a charging current so as to charge the battery module 417 with selected power among one or more types of power that can be supplied from the first electronic device 420, under a control of the control module 418.

According to an embodiment, when power having a second voltage (for example, 9V) is provided from among power having a pre-configured first voltage (for example, 5V) and power having a second voltage (for example, 9V) which can be supplied from the first electronic device 420, the charging power control module 413 may change a charging voltage so as to charge the battery module 417 with power having a second voltage (for example, 9V), under a control of the control module 418.

According to various embodiments, the device 410 can be configured to be a charger. The output terminal module 414 can be connected to a second electronic device 430 capable of receiving one or more types of power from the device 410 The output interface, can be for example, a micro USB connector, to which the second electronic device 430 is connected. Where the electronic device 410 is configured to be to be a charger to the second electronic device 430, discharging communication module 415 of the communication module 435, operably connected to the output terminal module 414, determines one or more types of power capable of being received by the second electronic device 430. The discharging communication module 415 can provide this information to the control module 418. The control module 418 can cause the discharging power control module 416 of the power control module 440 to set a discharging current so as to cause the battery module 417 to discharge power to the second electronic device 430 in accordance with the one or more types of power capable of being received by the second electronic device 430.

According to various embodiments, the discharging communication module 415 can receive, from the second electronic device 430 connected to the output terminal module 414, information on one or more types of power (for example, AC or DC power, supply voltage, maximum transmittable current, etc.) capable of being received by the second electronic device 430.

The discharging communication module 415 of the communication module 435 can be operably connected to the output terminal module 414 to communicate with the second electronic device 430. According to an embodiment, when the second electronic device 430 is connected to the output terminal module 414, the discharging communication module 415 may progress communication with the second electronic device 430 according to a predetermined communication protocol and receive information on one or more types of power capable of being received by the second electronic device 430. The foregoing can be via the input terminal module 411.

According to an embodiment, when the second electronic device 430 is connected to the output terminal module 414, the discharging communication module 415 may progress communication with the second electronic device 430 according to a predetermined communication protocol and transmit information on one or more types of power that can be used in the device 410 to the second electronic device 430. The foregoing can be via the input terminal module 414.

According to an embodiment, when the second electronic device 430 is connected to the output terminal module 414, the second electronic device 430 is to be a master electronic device, and the device 410 is to be a slave electronic device, the discharging communication module 415 may receive information on power selected as charging power by the second electronic device 430 among one or more types of power from the second electronic device 430.

According to an embodiment, when information on the selected power among the one or more types of power is received from the second electronic device 430, the discharging communication module 415 may transmit information indicating that the selected power is to be used as discharging power to the control module 418.

According to an embodiment, the discharging communication module 415 may be requested to provide power having a second voltage (for example, 9V) from the second electronic device 430 as discharging power, when the second electronic device 430 can be provided with power having a pre-configured first voltage (for example, 5V) and power having a voltage (for example, 9V) higher than the pre-configured first voltage.

According to an embodiment, the discharging communication module 415 may transmit, to the control module 418, information indicating that power having a second voltage (for example, 9V) is to be used as discharging power if requested from the second electronic device 430 to provide power having the second voltage (for example, 9V) as discharging power, when the second electronic device 430 can be provided with power having a pre-configured first voltage (for example, 5V) and power having a voltage (for example, 9V) higher than the pre-configured first voltage.

According to various embodiments, the discharging power control module 416 can output and discharge, to the second electronic device 420, power of the battery module 417 as a discharging condition corresponding to selected power among one or more types of power.

According to an embodiment, the charging power control module 416 may change a discharging current so as to discharge the battery module 417 with selected power among one or more types of power that can be provided to the second electronic device 430, under a control of the control module 418.

According to an embodiment, when requested to provide power having a second voltage (for example, 9V) among power having a pre-configured first voltage (for example, 5V) and power having the second voltage (for example, 9V) to the second electronic device 430, the discharging power control module 416 may change a discharging voltage so as to discharge the battery module 417 with power having the second voltage (for example, 9V), under a control of the control module 418.

According to various embodiments, the battery module 417 includes a battery circuit that can charge or discharge power, and the battery circuit can be fixed as either a series connection or a parallel connection.

According to various embodiments, the control module 418 may change a charging condition of the charging power control module 413 or a discharging condition of the discharging power control module 416 to correspond to the selected power among the one or more types of power.

According to an embodiment, the control module 418 may change a charging voltage of the charging power control module 413 to correspond to selected power among the one or more types of power.

According to an embodiment, the control module 418 may change a charging voltage of the charging power control module 413 in order for the charging power control module 413 to be able to charge the battery module 417 with power having the second voltage (for example, 9V), when receiving, from the charging communication module 412, information indicating that power having a second voltage (for example, 9V) is to be used as charging power among power having a pre-configured first voltage (for example, 5V) and power having a second voltage (for example, 9V).

According to an embodiment, the control module 418 may change a discharging voltage of the discharging power control module 416 to correspond to selected power among the one or more types of power.

According to an embodiment, when receiving, from the discharging communication module 415, information indicating that power having a second voltage (for example, 9V) is to be used as discharging power among power having a pre-configured first voltage (for example, 5V) and power having a second voltage (for example, 9V), the control module 418 may change a discharging voltage of the discharging power control module 416 in order for the discharging power control module 416 to be able to output and discharge the power of the battery module 417 as power having the second voltage (for example, 9V).

According to an embodiment, when the first electronic device 420 (for example, a charger) is connected to the input terminal module 411, and the second electronic device 430 is connected to the output terminal module 414 at the same time, the control module 418 may close a first switch (SW1) and provide power supplied from the first electronic device 420 to the second electronic device 430. Closure of the first switch (SW1) causes effectively a connection path from the first electronic device 420 to the input terminal module 411, to the communication module 435, to the output terminal module 414 to the second electronic device 430.

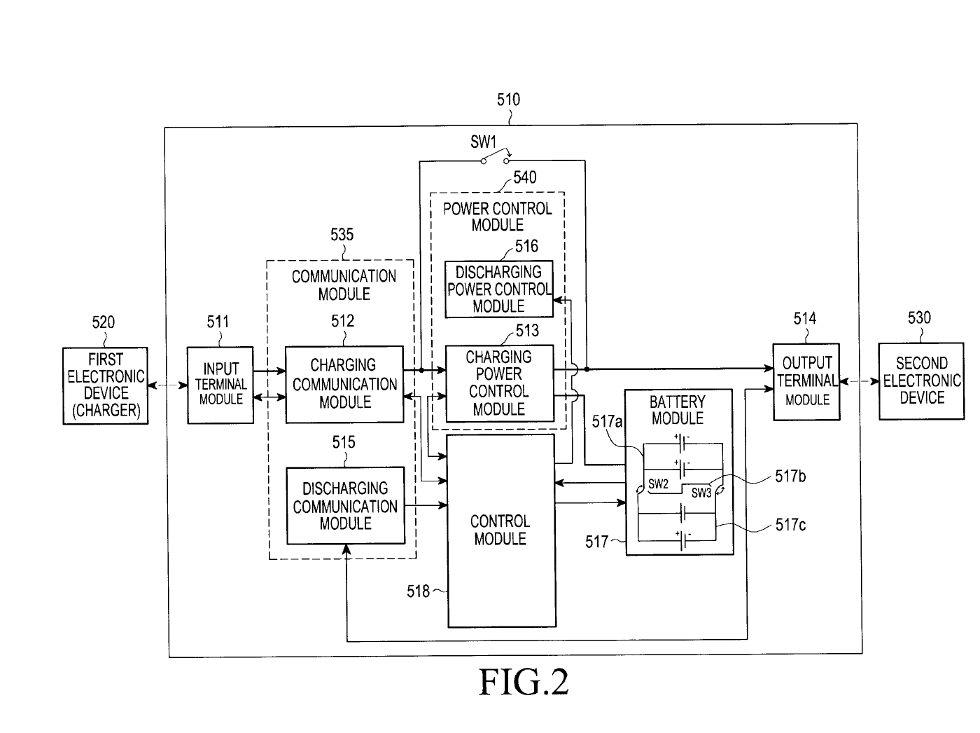

FIG. 2 shows a block diagram of a device 510 with an unfixed circuit connection of a battery according to various embodiments of the present disclosure. Referring to FIG. 2, the device 510 may include an input terminal module 511, an output terminal module 514, a communication module 535, a power control module 540, a battery module 517, and a control module 518. The communication module 535 may include a charging communication module 512 and a discharging communication module 515 that receives one or more types of power. The power control module may include a charging power control module 513 and discharging power control module 516 configured to charge or discharge the battery module with selected power among the one or more types of power. In the device 510, the input terminal module 511, the charging communication module 512, the charging power control module 513, the output terminal module 514, the discharging communication module 515, and the discharging power control module 516 may perform the same functions, respectively, as the input terminal module 411, the charging communication module 412, the charging power control module 413, the output terminal module 414, the discharging communication module 415, and the discharging power control module 416 in the device 410 of FIG. 1.

According to various embodiments, the battery module 517 includes a battery circuit that can charge or discharge power, and the battery circuit can be changed to either a series connection or a parallel connection under a control of the control module 518. According to an embodiment, the battery module 517 may include two or more switches (SW2, SW3) for changing the battery circuit to either a series connection or a parallel connection, under a control of the control module 518. According to various embodiments, the control module 518 may perform the same function as the control module 418 of the FIG. 1.

According to various embodiments, the battery module 517 may include a first voltage section 517a, a bridge 517b, a second voltage section 517c, a first switch SW2, and a second switch SW3. First switch SW2 is connected to the first voltage section 517a and can either make contact with the bridge 517b or the second voltage section 517c. The second switch SW3 is connected to the second voltage section 517c and can either make contact with the bridge 517b or the first voltage section 517a.

When the switches SW2, SW3 make contact with the bridge 517b, the first voltage section 517a and the second voltage section 517c are in series. The series configuration may be used when a power type corresponding to a higher voltage is provided or received from the electronic device 510.

When the switches SW2, SW3 make contact with the other sections 517a/517c, the voltage sections 517a and 517c are connected in parallel. The parallel configuration may be used when a power type corresponding to a lower voltage is provided or received from the electronic device 510.

According to various embodiments, when receiving information indicating that one power is selected one among one or more types of power from the charging communication module 512, the control module 518 may change a connection scheme of the battery circuit of the battery module 517 to correspond to the selected power.

According to an embodiment, when receiving, from the charging communication module 512, information indicating that power having a second voltage (for example, 9V) is to be used as charging power among power having a pre-configured first voltage (for example, 5V) and power having a second voltage (for example, 9V), the control module 518 may change the battery circuit of the battery module 517 into a series connection.

According to an embodiment, when receiving, from the charging communication module 512, information indicating that power having a first voltage (for example, 5V) is to be used as charging power among power having a pre-configured first voltage (for example, 5V) and power having second a voltage (for example, 9V), the control module 518 may change the battery circuit of the battery module 517 into a parallel connection.

According to an embodiment, when receiving, from the discharging communication module 515, information indicating that power having a second voltage (for example, 9V) is to be used as discharging power among power having a pre-configured first voltage (for example, 5V) and power having a second voltage (for example, 9V), the control module 518 may change the battery circuit of the battery module 517 into a series connection.

According to an embodiment, the control module 518 may change the battery circuit of the battery module 517 into a parallel connection, when receiving, from the discharging communication module 515, information indicating that power having a first voltage (for example, 5V) is to be used as discharging power among power having a pre-configured first voltage (for example, 5V) and power having a second voltage (for example, 9V).

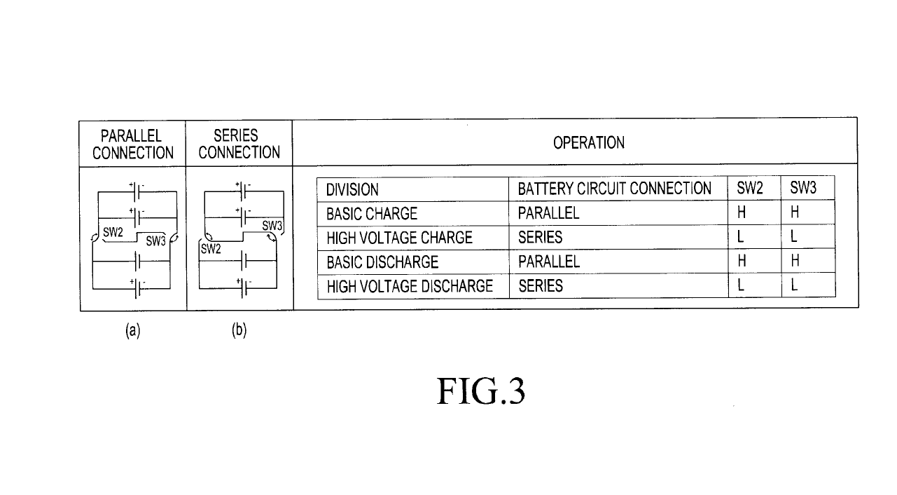

FIG. 3 is a diagram illustrating a signal for controlling a connection scheme of a battery module according to a type of charging power in a device in which a circuit connection of a battery is not fixed according to various embodiments of the present disclosure. Referring to FIG. 3, according to an embodiment, for the case of a main voltage charging supplied with power having a first voltage from the first electronic device 520 (for example, a charger), or for the case of a main voltage discharging that supplies power having a first voltage to the second electronic device 530, the control module 518 may transmit a “High” signal to the two or more switches (SW2, SW3) of the battery module 517 respectively, and can change the battery circuit into a series connection as shown in (b) of FIG. 3 (causing switches SW2, SW3 to make contact with the bridge 517b).

According to an embodiment, for the case of a second voltage charging supplied with power having a second voltage from the first electronic device 520 (for example, a charger), or for the case of a second voltage discharging that supplies power having a second voltage to the second electronic device 530, the control module 518 may transmit a “Low” signal to the two or more switches (SW2, SW3) of the battery module 517 respectively, and can change the battery circuit into a parallel connection as shown in (a) of FIG. 3 (switches SW2, SW3 make contact with voltage sections 517a and 517c).

According to various embodiments, the communication module can be configured to receive one or more types of power, the power control module can be configured to charge or discharge the battery module with selected power among the one or more types of power, and the control module can be configured to change the charging condition or discharging condition of the power control module so as to charge or discharge the battery module to correspond to the selected power among the one or more types of power.

According to various embodiments, the communication module includes a charging communication module that decides one or more types of power which can be provided from the electronic device, via communication with an electronic device connected to an input terminal module; and a discharging communication module that decides one or more types of power which can be provided to another electronic device, via communication with the another electronic device connected to an output terminal.

According to various embodiments, the charging communication module is configured to transmit selected power among the one or more types of power to the electronic device connected to the input terminal module.

According to various embodiments, the discharging communication module is configured to receive selected power among the one or more types of power from another electronic device connected to the output terminal.

According to various embodiments, the power control module may include: a charging power control module that changes a charging current so as to charge the battery module with selected power among the one or more types of power according to the charging condition to charge the battery module with the selected power; and a discharging power control module that changes the charging current so as to discharge the power of the battery module with selected power among the one or more types of power according to the discharging condition and then outputs and discharges the power of the battery module with the selected power.

According to various embodiments, a battery circuit of the battery module is fixed as at least one of a series connection or a parallel connection.

According to various embodiments, the control module may change, when the battery module includes two or more switches, a battery circuit of the battery module into a series connection or a parallel connection by controlling the two or more switches.

According to various embodiments, the control module can be configured to change the battery circuit of the battery module into a series connection by controlling the two or more switches, when selected power among the one or more types of power has a second voltage (for example, a high voltage, 9V) higher than a first voltage (for example, a main voltage, 5V); and to change the battery circuit of the battery module to parallel connection by controlling the two or more switches when selected power among the one or more types of power has a third voltage (for example, a low voltage, 3V) lower than the first voltage.

According to various embodiments, the control module is configured to connect an electronic device to another electronic device by controlling the switch, when the electronic device for supplying power to the device and the another electronic device for receiving power are connected at the same time.

According to various embodiments, the power includes power having a DC voltage.

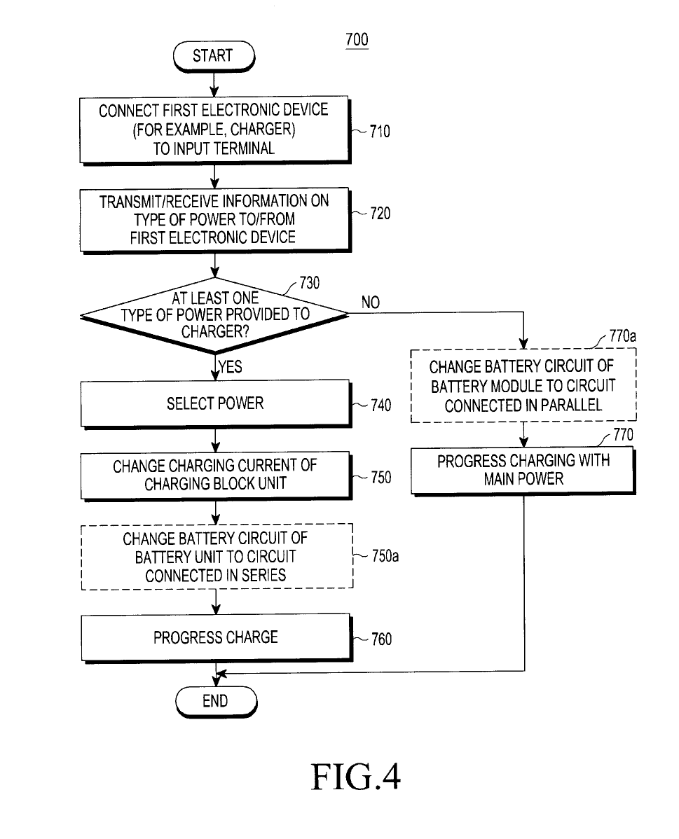

FIG. 4 shows a flow chart illustrating a power charging method 700 in a device according to various embodiments of the present disclosure. Referring to FIG. 4 above, in the operation 710, the device (the device 410 of FIG. 1 or the device 510 of FIG. 2) can be connected to the first electronic device 420/520 (for example, a charger) capable of supplying power to the device via an input terminal module. In operation of the 710, when the device is connected to the first electronic device (for example, a charger) 420/520, the device can be configured as a master electronic device, and the first electronic device can be configured to as a slave electronic device.

In operation 720, the charging communication module 412/512 may transmit and receive information on the type of power (e.g., AC or DC power, supply voltage, maximum transmittable current, etc.) in order to communicate with the first electronic device 420/520. In operation 730, the charging communication module 412/512 can determine whether it has received information indicating that one or more types of power can be supplied from the first electronic device 420/520. In the operation 730, when determining based on the reception of information indicating that one or more types of power can be supplied from the first electronic device 420/520, the charging communication module 412/512 may select a predetermined charging power among the one or more types of power, and transmit information on the selected power as information on charging power to the first electronic device 420/520 and the control module 418/518 in operation 740.

In operation 750, the control module 418/518 may change, when receiving information on the charging power from the charging communication module 412/512, a charging current of the charging power control module 413/513 so as to charge the battery module 417/517 with the charging power according to a charging condition which corresponds to the charging power. For example, when charging power corresponds to power having a second voltage (for example, 9V) higher than the first voltage (for example, 5V), the control module 418/518 may change the charging current of the charging power control module 413/513 so as to charge the battery module with power having the second voltage (for example, 9V).

When the device includes the battery module 517 shown in FIG. 2, the control module may change the battery circuit of the battery module 517 to a connection scheme corresponding to the charging power in operation 750a, additionally. For example, when the charging power corresponds to power having a second voltage (for example 9V) higher than a first voltage (for example, 5V), the control module may change the battery circuit of the battery module 517 into a circuit connected in series, (b).

In operation 760, the charging power control module 413/513 may charge the battery module with charging power received from the charging communication module. In the operation 730, when determining on the reception of information indicating that one main power can be supplied from the first electronic device, the charging communication module may transmit information relating to the main power as information on the charging power to the control module.

In operation 770, the charging power control module may charge the battery module with a main power having a first voltage received from the first electronic device, under a control of the control module. In another case, in the operation 740, when selecting power having a first voltage as the charging power from among the one or more types of power received from the first electronic device, the charging communication module may perform the operation 770.

When the device includes the battery module 517 shown in FIG. 2, the control module may change the battery circuit of the battery module 517 to a connection scheme corresponding to the charging power in operation 770a, additionally. For example, when the charging power corresponds to power having a first voltage (for example, 5V), the control module may change the battery circuit of the battery module 517 into a circuit connected in parallel. When the battery circuit of the battery module 517 is pre-configured as a circuit connected in parallel (a), the control module may not perform a connection scheme changing operation for the battery circuit of the battery module 517.

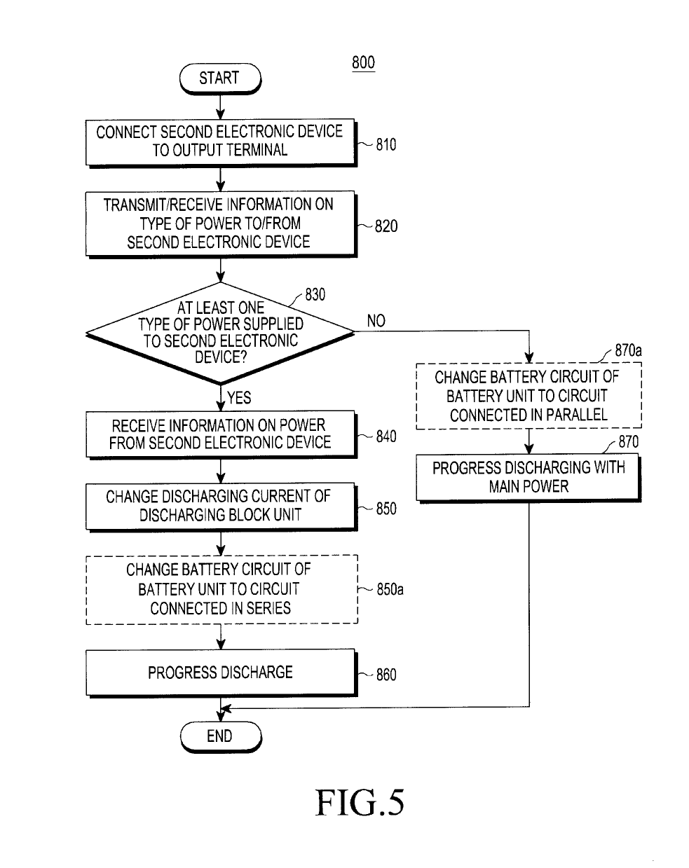

FIG. 5 shows a flow chart illustrating power discharging method 800 in a device according to various embodiments of the present disclosure. Referring to FIG. 5, in operation 810, the device (device 410 of FIG. 1 or the device 510 of FIG. 2) can be connected to the second electronic device 430/530 capable of receiving power from the device via an output terminal module 414/514. In the operation 810, when the device 410/510 is connected to the second electronic device 430/530, the second electronic device 430/530 can be configured as a master electronic device, and the device 410/510 can be configured as a slave electronic device.

In operation 820, the discharging communication module 415/515 may transmit and receive information on the type of power (e.g., AC or DC power, supply voltage, maximum transmittable current, etc.) in order to communicate with the second electronic device 430/530. In operation 830, the discharging communication module 415/515 can determine whether it has receive information indicating that one or more types of power can be provided to the second electronic device 430/530. In the operation 830, when determining on the reception of information indicating that one or more types of power can be supplied to the second electronic device 430/530, the discharging communication module 415/515 may receive information on power selected as discharging power among the one or more types of power from the second electronic device 430/530 in operation 840. In the operation 840, the discharging communication module 415/515 may transmit information on the discharging power received from the second electronic device 430/530 to the control module.

In operation 850, when receiving information on the discharging power from the discharging communication module 415/515, the control module 418/518 may change a charging current of the discharging power control 416/516 so as to discharge the battery module with the discharging power according to a discharging condition which corresponds to the discharging power. For example, when the charging power corresponds to power having the second voltage (for example, 9V) higher than the first voltage (for example, 5V), the control module may change the discharging current of the discharging power control module 416/516 so as to output and discharge the power of the battery module with power having the second voltage (for example, 9V).

When the device includes the battery module 517 shown in FIG. 2, the control module 518 may change the battery circuit of the battery module 517 to a connection scheme corresponding to the discharging power in operation 850a, additionally. The control module, for example, when the discharging power corresponds to power having the second voltage (for example 9V) higher than a first voltage (for example, 5V), may change the battery circuit of the battery module 517 into a circuit connected in series (b).

In operation 860, the discharging power control module 415/515 may discharge the battery module while outputting the power of the battery module 417/517 to the second electronic device 430/530 as the charging power.

In the operation 830, when determining on the reception of information that can supply one main power from the second electronic device 430/530, the discharging communication module may transmit, to the control module 418/518, information on the main power as the information on the discharging power supply.

In operation 870, the discharging power control module may discharge the battery module 417/517 while outputting the power of the battery module 417/517 as power having the first voltage corresponding to the charging power to the second electronic device, under a control of the control module. In another case, in the operation 840, when receiving power having a first voltage as the charging power from among the one or more types of power from the second electronic device 430/530, the discharging communication module may perform the operation 870.

When the device includes the battery module 517 shown in FIG. 2, the control module may change the battery circuit of the battery module 517 to a connection scheme corresponding to the discharging power in operation 870a, additionally. For example, when the discharging power corresponds to power having a first voltage (for example, 5V), the control module may change the battery circuit of the battery module 517 to a circuit connected in parallel (a). When the battery circuit of the battery module 517 is pre-configured as a circuit connected in parallel (a), the control module may not perform a connection scheme changing operation for the battery circuit of the battery module 517.

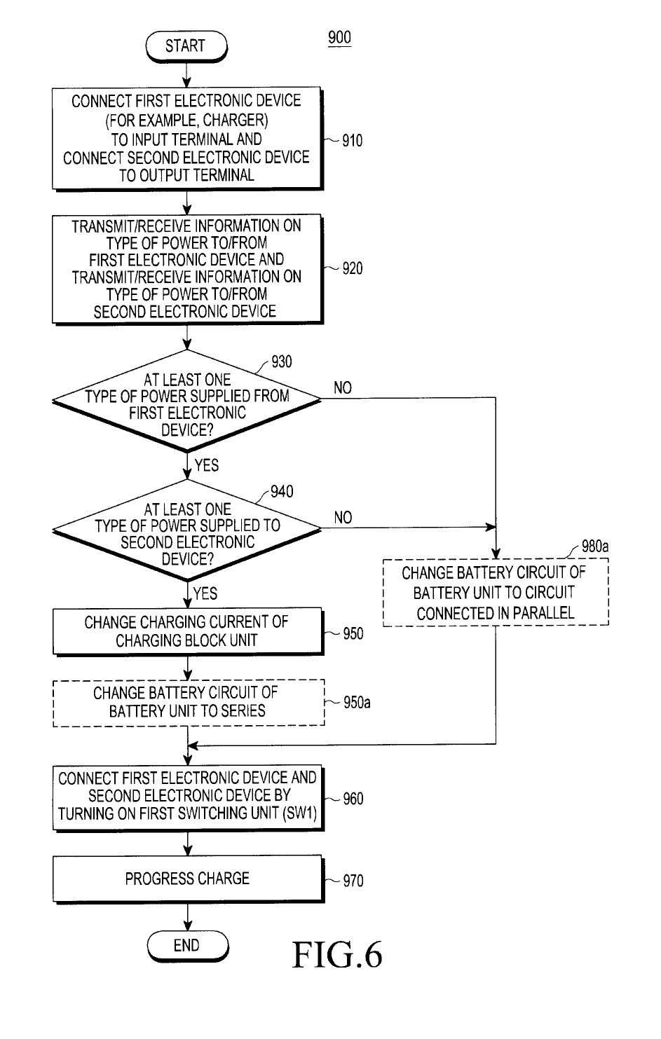

FIG. 6 shows a flow chart illustrating a simultaneous charging method by a circuit connection of a battery in a device according to various embodiments of the present disclosure. Referring to FIG. 6, in operation 910, the device (the device 410 of FIG. 1 or the device 510 of FIG. 2) can be connected to the first electronic device (for example, a charger) 420/520 capable of supplying power to the device 410/510 via a connection input terminal module 411/511. Simultaneously in the operation 910, the device 410/510 can be connected to the second electronic device capable 430/530 of receiving power to the device via the output terminal module 414/514. In operation 920, the charging communication module 412/512 may transmit and receive information on the type of power (e.g., AC or DC power, supply voltage, maximum transmittable current, etc.) in order to communicate with the first electronic device 420/520 and, the discharging communication module 415/515 may transmit and receive information on the type of power (e.g., AC or DC power, supply voltage, maximum transmittable current, etc.) in order to communicate with the second electronic device. In operation 930, the charging communication module 412/512 can determine whether it received information indicating that one or more types of power can be supplied from the first electronic device. In the operation 930, when determining on the reception of information indicating that one or more types of power can be supplied from the first electronic device, the charging communication module 412/512 may select a predetermined charging power among the one or more types of power, and transmit, to the first electronic device 420/520 and the control module 418/518, information on the selected power as information on the charging power.

In operation 940, the discharging communication module 415/515 can determine whether it received information indicating that one or more types of power which can be supplied to the second electronic device 430/530. In the operation 940, when determining on the reception of information indicating that one or more types of power can be supplied to the second electronic device 430/530, the discharging communication module 415/515 may transmit received information from the second electronic device 430/530 on discharging power to the control module 418/518.

In operation 950, when receiving information on the charging power from the charging communication module 412/512, the control module may change a charging current of the charging power control module 413/513 so as to charge the battery module 417/517 with the charging power according to a charging condition which corresponds to the charging power. The control module, for example, when charging power is power having a second voltage (for example, 9V) higher than the first voltage (for example, 5V), may change the charging current of the charging power control module 417/517 so as to charge the battery module with power having the second voltage (for example, 9V).

When the device includes the battery module 517 shown in FIG. 2, the control module 418/518 may change the battery circuit of the battery module 517 to a connection scheme corresponding to the charging power in operation 950a, additionally. The control module, for example, when the charging power is power having a second voltage (for example 9V) higher than a first voltage (for example, 5V), may change the battery circuit of the battery module 517 to a circuit connected in series (b). In operation 960, the control module may turn on the first switch (SW1), connect the first electronic device and the second electronic device and then directly provide charging power supplied from the first electronic device 420/520 to the second electronic device 430/530.

In operation 970, the charging power control module 412/512 may charge the battery module with a main power having a first voltage received from the first electronic device 420/520, under a control of the control module 418/518.

In the operation 930, when the charging communication module 412/512 determines on the reception of information that one main power can be supplied from the first electronic device 420/520, or in the operation 940, when the discharging communication module 415/515 determines on the reception of information that the one main power can be supplied to the second electronic device 430/530, the charging power control module 413/513, in operation 980a, may change the battery module with the main power having the first voltage received from the first electronic device 420/520 and received from the charging communication module 435/535, under the control of the control module 418/518.

When the device includes the battery module 517 shown in FIG. 2, the control module may change the battery circuit of the battery module 517 to a connection scheme corresponding to the charging power in operation 980a, additionally. For example, when the charging power is power having a first voltage (for example, 5V), the control module may change the battery circuit of the battery module 517 to a circuit connected in parallel (a). When the battery circuit of the battery module 517 is pre-configured as a circuit connected in parallel, the control module may not perform a connection scheme changing operation for the battery circuit of the battery module 517. After operation 980a, operations 960 and 970 are performed.

According to various embodiments, a method for controlling power in a device is provided. The method includes: receiving one or more types of power; changing a charging condition or a discharging condition of the power control module in order to charge or discharge a battery module with selected power among the one or more types of power; and charging or discharging the battery module to correspond to the selected power among the one or more types of power.

According to various embodiments, wherein a battery circuit of the battery module is fixed as at least one of a series connection or a parallel connection.

According to various embodiments, the method may further include: deciding one or more types of power which can be provided from the electronic device via communication with the electronic device, when the electronic device is connected to an input terminal module of a device; changing a charging current of a charging power control module to charge the battery module according to the charging condition; and transmitting selected power among the one or more types of power to the electronic device, and charging the battery module by receiving the selected power provided from the electronic device.

According to various embodiments, the method may further include: determining a voltage of the selected power when the battery module includes two or more switches; when the selected power has a second voltage higher than the first voltage, changing the battery circuit of the battery module into a series connection by controlling the two or more switches; and when selected power among the one or more types of power has a third voltage lower than the first voltage, changing the battery circuit of the battery module into a parallel connection by controlling the two or more switches.

According to various embodiments, the method may further include: deciding one or more types of power which can be provided to another electronic device via communication with the another electronic device, when the another electronic device is connected to an output terminal module of a device; receiving selected power among the one or more types of power from the another electronic device; changing a discharging current of a discharging power control module to discharge the battery module according to the discharging condition; and outputting and discharging the power of the battery module with the selected power.

According to various embodiments, the method may further include: determining a voltage of the selected power when the battery module includes two or more switches; when the selected power has a second voltage higher than the first voltage, changing the battery circuit of the battery module into a series connection by controlling the two or more switches; and when selected power among the one or more types of power has a third voltage lower than the first voltage, changing the battery circuit of the battery module into a parallel connection by controlling the two or more switches.

According to various embodiments, the method may further include: deciding one or more types of power which can be supplied from an electronic device via communication with the electronic device, and deciding one or more types of power which can be provided to another electronic device via communication with the another electronic device, when the electronic device is connected to an input terminal module of the device, and at the same time, another electronic device is connected to an output terminal module of the device; changing a charging current of a charging power control module to charge the battery module according to the charging condition, transmitting selected power among the one or more types of power to the electronic device, and charging the battery module by receiving the selected power supplied from the electronic device; and providing the selected power provided by the electronic device to the another electronic device by connecting the electronic device and the another electronic device.

According to various embodiments, the method may further include: determining a voltage of the selected power when the battery module includes two or more switches; changing the battery circuit of the battery module into a series connection by controlling the two or more switches, when the selected power has a second voltage higher than a first voltage; and changing the battery circuit of the battery module into a parallel connection by controlling the two or more switches, when selected power among the one or more types of power has a third voltage lower than the first voltage.

According to various embodiments, the power includes power having a DC voltage.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, or a combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

While the disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. A device, comprising:
a communication module configured to receive one or more types of power, and select from the one or more types of power, thereby resulting in a selected power;
a power control module configured to charge or discharge a battery module with the selected power among the one or more types of power; and
a control module configured to change a charging condition or discharging condition of the power control module to charge or discharge the battery module to correspond to the selected power.

2. The device as claimed in claim 1, wherein the communication module comprises:
a charging communication module that decides one or more types of power which can be supplied from an electronic device, via communication with the electronic device connected to an input terminal module, and
a discharging communication module that decides one or more types of power which can be provided to another electronic device, via communication with the another electronic device connected to an output terminal module.

3. The device as claimed in claim 2, wherein the charging communication module is configured to transmit the selected power among the one or more types of power which can be supplied from the electronic terminal connected to the input terminal module.

4. The device as claimed in claim 2, wherein the discharging communication module is configured to receive the selected power among the one or more types of power which can be provided to the another electronic device connected to the output terminal module.

5. The device as claimed in claim 1, wherein the power control module comprises:
a charging power control module that changes a charging current so as to charge the battery module with the selected power according to the charging condition and then charges the battery module with the selected power; and
a discharging power control module that changes a discharging current so as to discharge the battery module with the selected power according to the discharging condition and then outputs and discharges the power of the battery module with the selected power.

6. The device as claimed in claim 1, wherein a battery circuit of the battery module is fixed as at least one of a series connection or a parallel connection.

7. The device as claimed in claim 1, wherein the control module changes a battery circuit of the battery module into a series connection or a parallel connection by controlling two or more switches.

8. The device as claimed in claim 7, wherein the control module is configured to:
change the battery circuit of the battery module into the series connection by controlling the two or more switches, when the selected power among the one or more types of power has a second voltage higher than a first voltage; and
change the battery circuit of the battery module into the parallel connection by controlling the two or more switches, when the selected power among the one or more types of power has a third voltage lower than the first voltage.

9. The device as claimed in claim 1, wherein the control module is configured to connect the electronic device and another electronic device by controlling a switch, when the electronic device for supplying power to the device and the another electronic device for receiving power are connected to the device at the same time.

10. The device as claimed in claim 1, wherein the power includes power having a DC voltage.

11. A method for controlling power in a device, the method comprising:
receiving one or more types of power;
selecting from the one or more types of power, thereby resulting in a selected power.
changing a charging condition or a discharging condition of a power control module to charge or discharge a battery module with the selected power; and
charging or discharging the battery module to correspond to the selected power.

12. The method as claimed in claim 11, wherein a battery circuit of the battery module is fixed as at least one of a series connection or a parallel connection.

13. The method as claimed in claim 11, the method further comprising:
wherein selecting from the one or more types of power further comprises deciding one or more types of power which can be supplied from an electronic device via communication with the electronic device, when the electronic device is connected to an input terminal module of the device;
wherein changing a charging condition further comprises changing a charging current of a charging power control module to charge the battery module according to the charging condition; and
transmitting the selected power to the device, and wherein charging or discharging further comprises charging the battery module by receiving the selected power supplied from the device.

14. The method as claimed in claim 13, the method further comprising:
determining a voltage of the selected power when the battery module includes two or more switches;
changing a battery circuit of the battery module into a series connection by controlling the two or more switches when the selected power has a second voltage higher than a first voltage; and
changing the battery circuit of the battery module into a parallel connection by controlling the two or more switches when selected power among the one or more types of power has a third voltage lower than the first voltage.

15. The method as claimed in claim 11, the method further comprising:
wherein selecting from the one or more types of power further comprises deciding one or more types of power which can be provided to another electronic device via communication with the another electronic device, when the another electronic device is connected to an output terminal module of the device;
providing the selected power to the another electronic device;
wherein changing the charging condition or the discharging condition further comprises changing a discharging current of a discharging power control module for discharging of the battery module according to the discharging condition; and
wherein charging or discharging further comprises outputting and discharging power of the battery module to correspond to the selected power.

16. The method as claimed in claim 15, the method further comprising:
determining a voltage of the selected power when the battery module includes two or more switches;
changing the battery circuit of the battery module into a series connection by controlling the two or more switches, when the selected power corresponds to power having a second voltage higher than a first voltage; and
changing the battery circuit of the battery module into a parallel connection by controlling the two or more switches, when the selected power among the one or more types of power has a third voltage lower than the first voltage.

17. The method as claimed in claim 11, the method further comprising:
deciding one or more types of power which can be supplied from an electronic device via communication with the electronic device, and deciding one or more types of power which can be provided to another electronic device via communication with the another electronic device, when the electronic device is connected to an input terminal module of the device, and at the same time, another electronic device is connected to an output terminal module of the device;
changing a charging current of a charging power control module to charge the battery module according to the charging condition, transmitting information about the selected power to the device, and charging the battery module by receiving the selected power supplied from the electronic device; and
providing the selected power provided by the electronic device to the another electronic device by connecting the electronic device and the another electronic device.

18. The method as claimed in claim 17, the method further comprising:
determining a voltage of the selected power when the battery module includes two or more switches;
changing the battery circuit of the battery module into a series connection by controlling the two or more switches, when the selected power has a second voltage higher than a first voltage; and
changing the battery circuit of the battery module into a parallel connection by controlling the two or more switches, when selected power among the one or more types of power has a third voltage lower than the first voltage.

19. The method as claimed in claim 18 wherein changing battery circuit into the series connections further comprises controlling the two or more switches to connect to a bridge.

20. The method as claimed in claim 11, wherein the power includes power having a DC voltage.
